(19) United States
(12) Patent Application Publication
(10) Pub. No.: US 2024/0097200 A1
(43) Pub. Date: Mar. 21, 2024

(54) LITHIUM-ION RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventor: Shunya MARUYAMA, Toyohashi-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/369,644

(22) Filed: Sep. 18, 2023

(30) Foreign Application Priority Data
Sep. 21, 2022 (JP) 2022-149999

(51) Int. Cl. H01M 10/0587; H01M 4/13; H01M 10/0525; H01M 50/491; H01M 50/531

(52) U.S. Cl. CPC H01M 10/0587; H01M 4/13; H01M 10/0525; H01M 50/491; H01M 50/531; H01M 2004/021

(57) ABSTRACT

A lithium-ion rechargeable battery includes a negative electrode plate including a negative electrode substrate and a negative electrode mixture layer applied to the substrate, a positive electrode plate including a positive electrode substrate and a positive electrode mixture layer applied to the substrate, a separator arranged between the negative electrode plate and the positive electrode plate, and a non-aqueous electrolyte. The negative electrode substrate includes a negative electrode connection portion that projects from the negative electrode mixture layer in a first width direction. The positive electrode substrate includes a positive electrode connection portion that projects from the positive electrode mixture layer in a second width direction. The negative electrode plate has a thickness that increases in the first width direction. The positive electrode plate has a thickness that increases in the second width direction. The separator has a porosity that increases in the second width direction.

### BACKGROUND

### 1. Field

The following description relates to a lithium-ion rechargeable battery.

### 2. Description of Related Art

A lithium-ion rechargeable battery includes a negative electrode plate, a positive electrode plate, a separator, and a non-aqueous electrolyte. The negative electrode plate includes a negative electrode substrate and a negative electrode mixture layer applied to the surface of the negative electrode substrate. The positive electrode plate includes a positive electrode substrate and a positive electrode mixture layer applied to the surface of the positive electrode substrate. The separator is arranged between the negative electrode plate and the positive electrode plate.

There is a lithium-ion rechargeable battery that varies the thicknesses of the negative electrode plate and the positive electrode plate in the width direction (refer to, for example, Japanese Laid-Open Patent Publication No. 2006-216461). The negative electrode plate includes a negative electrode connection portion electrically connected to a negative electrode external terminal, and the thickness of the negative electrode plate is increased toward the negative electrode connection portion. The positive electrode plate includes a positive electrode connection portion electrically connected to a positive electrode external terminal. The thickness of the positive electrode plate is increased toward the positive electrode connection. Thus, the thickness increases as the end where the positive electrode connection portion is located becomes closer. In such a lithium-ion rechargeable battery, the resistance is small at the negative electrode connection portion and the positive electrode connection portion where current concentrates. This improves the input/output properties.

However, in the above lithium-ion rechargeable battery, the resistance of the negative electrode plate varies in the width direction. Thus, for example, current flowing from the positive electrode plate to the negative electrode plate during charging may concentrate at a certain portion of the negative electrode plate in the width direction. Thus, there will be a tendency of lithium metal being deposited at where the current concentrates. This may, for example, adversely affect the input/output properties of the lithium-ion rechargeable battery. The deposition of metal may be limited by, for example, by reducing current during recharging. This will, however, adversely affect the input properties.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lithium-ion rechargeable battery includes a negative electrode plate including a negative electrode substrate and a negative electrode mixture layer applied to each of two surfaces of the negative electrode substrate, a positive electrode plate including a positive electrode substrate and a positive electrode mixture layer applied to each of two surfaces of the positive electrode substrate, a separator arranged between the negative electrode plate and the positive electrode plate, and a non-aqueous electrolyte. The negative electrode substrate includes a negative electrode connection portion that projects from the negative electrode mixture layer in a first width direction and is electrically connected to a negative electrode external terminal. The positive electrode substrate includes a positive electrode connection portion that projects from the positive electrode mixture layer in a second width direction opposite to the first width direction and is electrically connected to a positive electrode external terminal. The negative electrode plate has a thickness that increases in the first width direction. The positive electrode plate has a thickness that increases in the second width direction. The separator has a porosity that increases in the second width direction.

In another general aspect, in the negative electrode plate of the above lithium-ion rechargeable battery, the negative electrode mixture layer may have a thickness that increases in the first width direction, and in the positive electrode plate of the above lithium-ion rechargeable battery, the positive electrode mixture layer may have a thickness that increases in the second width direction.

In another general aspect, in the above lithium-ion rechargeable battery, the porosity of the separator may be such that the porosity at an end in the second width direction is 102% or greater with respect to the porosity at an end in the first width direction.

In another general aspect, in the above lithium-ion rechargeable battery, the negative electrode plate and the positive electrode plate when stacked entirely may have a thickness that is constant in a width direction.

Other features and aspects will be apparent from the following detailed description, the drawings, and the claims.

### BRIEF DESCRIPTION OF THE DRAWINGS

FIG. 1 is a perspective view of a lithium-ion rechargeable battery in accordance with one embodiment.

FIG. 2 is a diagram showing an electrode body in one embodiment in a partially spread out state.

FIG. 3 is a cross-sectional view showing the configuration of the electrode body in one embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

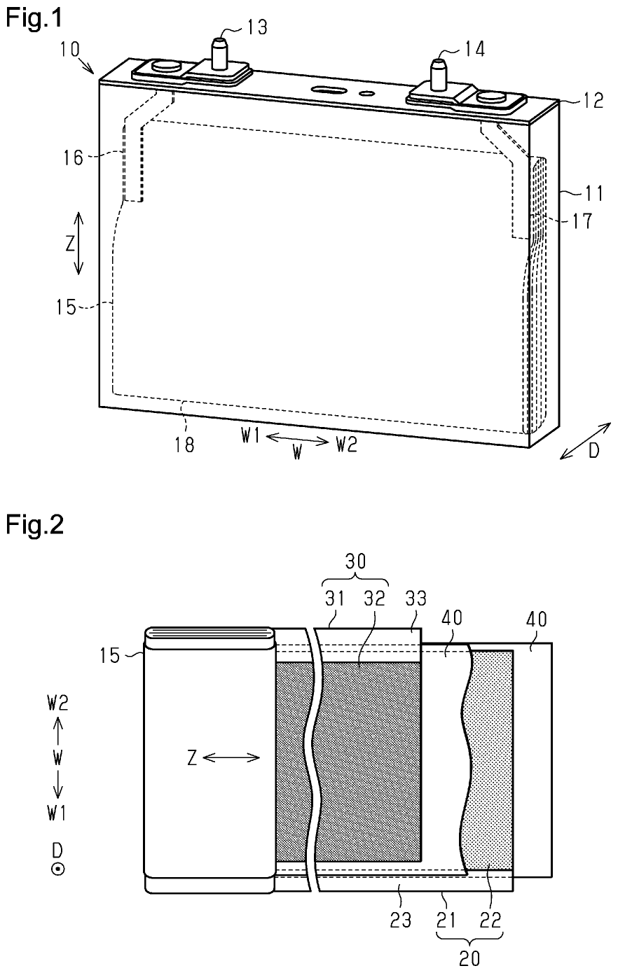

A lithium-ion rechargeable battery 10 according to one embodiment will now be described with reference to FIGS. 1 to 3.

Configuration of Lithium-Ion Rechargeable Battery 10

As shown in FIG. 1, the lithium-ion rechargeable battery 10 forms a cell battery. The lithium-ion rechargeable battery 10 includes a battery case 11 and a lid 12. The battery case 11 has an opening (not shown) at the top side. The lid 12 seals the opening. The battery case 11 is formed from metal such as an aluminum alloy. The lid 12 includes a negative electrode external terminal 13 and a positive electrode external terminal 14 used for charging and discharging power.

The lithium-ion rechargeable battery 10 includes an electrode body 15, a negative electrode current collector 16, and a positive electrode current collector 17. The electrode body 15 is accommodated in the battery case 11. The negative electrode current collector 16 connects the negative electrode of the electrode body 15 to the negative electrode external terminal 13. The positive electrode current collector 17 connects the positive electrode of the electrode body 15 to the positive electrode external terminal 14.

The lithium-ion rechargeable battery 10 includes a non-aqueous electrolyte 18. The non-aqueous electrolyte 18 is injected into the battery case 11. The lithium-ion rechargeable battery 10 forms a sealed battery case when the lid 12 is attached to the battery case 11. In this manner, the battery case 11 accommodates the electrode body 15 and the non-aqueous electrolyte 18.

Electrode Body 15

As shown in FIG. 2, the electrode body 15 includes a negative electrode plate 20, a positive electrode plate 30, and separators 40. The longitudinal direction of the electrode body 15 is referred to as the longitudinal direction Z. The thickness direction of the electrode body 15 is referred to as the thickness direction D. A direction intersecting the longitudinal direction Z and the thickness direction D of the electrode body 15 is referred to as the width direction W. One side of the width direction W is referred to as the first width direction W1, and the other side of the width direction W is referred to as the second width direction W2. In other words, the second width direction W2 is opposite to the first width direction W1.

The electrode body 15 is formed by rolling a stack of the negative electrode plate 20, the positive electrode plate 30, and the separators 40 about a rolling axis in the longitudinal direction Z. The rolling axis extends in the width direction W. The separators 40 are arranged between the negative electrode plate 20 and the positive electrode plate 30. Specifically, in the stack, the separator 40, the negative electrode plate 20, the separator 40, and the positive electrode plate 30 are stacked in this order.

The width direction W of the electrode body 15 coincides with the width directions of the negative electrode plate 20, the positive electrode plate 30, and the separators 40, which are in the form of strips before being rolled. The electrode body 15 is flattened in the thickness direction D. When the stack is rolled into the electrode body 15, the separator 40, the negative electrode plate 20, the separator 40, and the positive electrode plate 30 will be consistently superposed in this order in the thickness direction D.

Negative Electrode Plate 20

The negative electrode plate 20 serves as the negative electrode of the lithium-ion rechargeable battery 10.

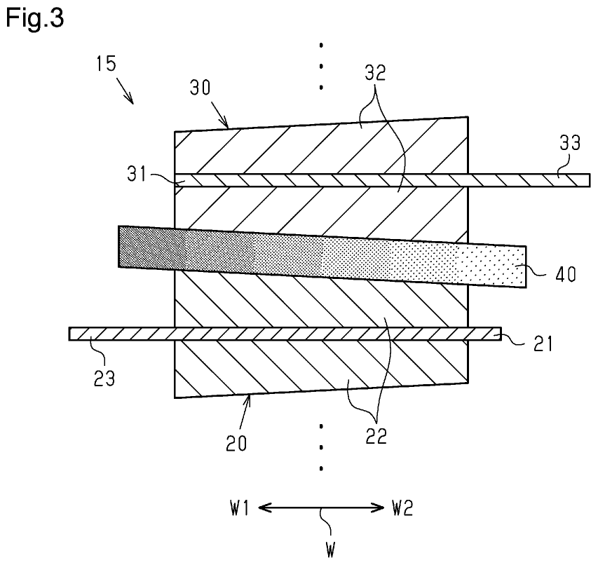

As shown in FIGS. 2 and 3, the negative electrode plate 20 includes a negative electrode substrate 21 and negative electrode mixture layers 22 applied to the surfaces of the negative electrode substrate 21. The negative electrode substrate 21 is a substrate of the negative electrode. The negative electrode mixture layers 22 are mixture layers of the negative electrode and are applied to the two surfaces of the negative electrode substrate 21.

The negative electrode substrate 21 includes a negative electrode connection portion 23. The negative electrode connection portion 23 is a region where the two surfaces of the negative electrode substrate 21 are free from the negative electrode mixture layer 22. The negative electrode connection portion 23 is arranged at the end of the electrode body 15 in the first width direction W1. In other words, the negative electrode connection portion 23 projects out of the negative electrode mixture layers 22 in the first width direction W1. The negative electrode connection portion 23 also projects outward from the positive electrode plate 30 and the separators 40 in the first width direction W1. The negative electrode connection portion 23 is connected to the negative electrode current collector 16 and thus electrically connected to the negative electrode external terminal 13.

In the present embodiment, the negative electrode substrate 21 is formed from a copper (Cu) foil. The negative electrode substrate 21 serves as a base for the negative electrode mixture layers 22. The negative electrode substrate 21 has the functionality of a current collecting member that collects electricity from the negative electrode mixture layers 22.

Each negative electrode mixture layer 22 includes a negative electrode active material and a negative electrode additive. The negative electrode plate 20 is produced by, for example, kneading the negative electrode active material and the negative electrode additive, applying the kneaded negative electrode composite material paste to the negative electrode substrate 21, and drying the negative electrode composite material paste.

The negative electrode active material is an active material of the negative electrode and has the capability to store and release lithium ions. The negative electrode active material may be, for example, a powdery carbon material such as graphite or the like.

The negative electrode additive is an additive of the negative electrode and includes a negative electrode solvent, a negative electrode binder, and a negative electrode thickener. The negative electrode solvent may be, for example, water or the like. The negative electrode binder may be, for example, styrene-butadiene rubber (SBR), polyvinylidene fluoride (PVDF), polyvinyl alcohol (PVA), or the like. The negative electrode thickener may be, for example, carboxymethyl cellulose (CMC) or the like. The negative electrode additive may further include, for example, a negative electrode conductive material or the like.

Positive Electrode Plate 30

The positive electrode plate 30 serves as the positive electrode of the lithium-ion rechargeable battery 10.

As shown in FIGS. 2 and 3, the positive electrode plate 30 includes a positive electrode substrate 31 and positive electrode mixture layers 32 applied to the surfaces of the positive electrode substrate 31. The positive electrode substrate 31 is a substrate of the positive electrode. The positive electrode mixture layers 32 are mixture layers of the positive electrode and are applied to the two surfaces of the positive electrode substrate 31.

The positive electrode substrate 31 includes a positive electrode connection portion 33. The positive electrode connection portion 33 is a region where the two surfaces of the positive electrode substrate 31 are free from the positive electrode mixture layer 32. The positive electrode connection portion 33 is arranged at the end of the electrode body 15 in the second width direction W2. In other words, the positive electrode connection portion 33 projects out of the positive electrode mixture layers 32 in the second width direction W2. The positive electrode connection portion 33 also projects outward from the negative electrode plate 20 and the separators 40 in the second width direction W2. The positive electrode connection portion 33 is connected to the positive electrode current collector 17 and thus electrically connected to the positive electrode external terminal 14. As shown in FIGS. 2 and 3, when the negative electrode plate 20, the positive electrode plate 30, and the separator 40 are stacked, the negative electrode substrate 21 includes the negative electrode connection portion 23 projecting out of the negative electrode mixture layers 22 in a first direction (corresponding to first width direction W1) of the rolling axis of the electrode body. Further, the positive electrode substrate 31 includes the positive electrode connection portion 33 projecting out of the positive electrode mixture layers 32 in a second direction (corresponding to second width direction W2) opposite to the first direction of the rolling axis of the electrode body. The positive electrode mixture layers 32 are smaller than the negative electrode mixture layers 22 in the width direction W. In other words, the negative electrode mixture layers 22 are larger than the positive electrode mixture layers 32 in the width direction W and project outward from the positive electrode mixture layers 32 in the first width direction W1 and the second width direction W2.

In the present embodiment, the positive electrode substrate 31 is formed from an aluminum (Al) foil or an Al alloy foil. The positive electrode substrate 31 serves as a base for the positive electrode mixture layers 32. The positive electrode substrate 31 has the functionality of a current collecting member that collects electricity from the positive electrode mixture layers 32.

Each positive electrode mixture layer 32 includes a positive electrode active material and a positive electrode additive. The positive electrode plate 30 is produced by, for example, kneading the positive electrode active material and the positive electrode additive, applying the kneaded positive electrode composite material paste to the positive electrode substrate 31, and drying the positive electrode composite material paste.

The positive electrode active material is an active material of the positive electrode and has the capability to store and release lithium. The positive electrode active material may be, for example, a ternary (NMC) lithium-containing composite oxide containing nickel, manganese, and cobalt, such as a lithium nickel cobalt manganese oxide (LiNiCoMnO₂). Instead, the positive electrode active material may be, for example, any one of lithium cobaltate (LiCoO₂), lithium manganate (LiMn₂O₄), and lithium nickelate (LiNiO₂). Instead, the positive electrode active material may be, for example, a lithium-containing composite oxide containing nickel, cobalt, and aluminum (NCA).

The positive electrode additive is an additive of the positive electrode and includes a positive electrode solvent, a positive electrode conductive material, and a positive electrode binder. The positive electrode solvent may be, for example, a non-aqueous solvent such as an NMP (N-methyl-2-pyrrolidone) solution. The positive electrode conductive material may be, for example, carbon fibers such as carbon nanotubes (CNT), carbon nanofibers (CNF), or the like. Alternatively, the positive electrode conductive material may be, for example, carbon black such as graphite, acetylene black (AB), Ketjen black, or the like. The positive electrode binder may be, for example, the same as the negative electrode binder. The positive electrode additive may further include, for example, a positive electrode thickener or the like.

Separator 40

The separators 40 are arranged between the negative electrode plate 20 and the positive electrode plate 30. The separators 40 are larger than the negative electrode mixture layers 22 and the positive electrode mixture layers 32 in the width direction W and project outward from the negative electrode mixture layers 22 and the positive electrode mixture layers 32 in the first width direction W1 and the second width direction W2. Each separator 40 holds the non-aqueous electrolyte 18. The separator 40 is a nonwoven fabric formed from a porous resin such as polypropylene. The separator 40 may be one of or a combination of a porous polymer film such as a porous polyethylene film, a porous polyolefin film, a porous polyvinyl chloride film, or the like, or a lithium-ion or ion-conductive polymer electrolyte film. When the electrode body 15 is immersed in the non-aqueous electrolyte 18, the non-aqueous electrolyte 18 permeates from the ends of the separators 40 toward the central portion.

Non-Aqueous Electrolyte 18

The non-aqueous electrolyte 18 is a composition in which supporting salt is contained in a non-aqueous solvent. In the present embodiment, the non-aqueous solvent may be ethylene carbonate (EC). The non-aqueous solvent may be one, two, or more types of materials selected from the group including propylene carbonate (PC), diethyl carbonate (DEC), dimethyl carbonate (DMC), ethyl methyl carbonate (EMC), and the like.

Examples of the supporting salt include LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like. The supporting salt may be one, two, or more types of lithium compounds (lithium salts) selected from the above examples. In this manner, the non-aqueous electrolyte 18 contains a lithium compound.

### Detailed Configuration of Present Embodiment

As shown in FIG. 3, the thickness of the negative electrode plate 20 increases in the first width direction W1. Specifically, in the negative electrode plate 20, the negative electrode mixture layers 22 are increased in thickness in the first width direction W1. In one example, the thickness of the negative electrode mixture layers 22 increases toward the end of the negative electrode plate 20 where the negative electrode connection portion 23 is located or as the end becomes closer. In the present embodiment, the negative electrode substrate 21 has a constant thickness in the width direction W.

Further, the thickness of the positive electrode plate 30 increases in the second width direction W2. Specifically, in the positive electrode plate 30, the positive electrode mixture layers 32 are increased in thickness in the second width direction W2. In one example, the thickness of the positive electrode mixture layers 32 increases toward the end of the positive electrode plate 30 where the positive electrode connection portion 33 is located or as the end becomes closer. In the present embodiment, the positive electrode substrate 31 has a constant thickness in the width direction W.

The negative electrode plate 20 and the positive electrode plate 30 are formed so that the total thickness of the stack is constant in the width direction W. As shown in FIG. 3, when the negative electrode plate 20, the positive electrode plate 30, and the separator 40 are stacked, a central stack portion of the stack of the negative electrode plate 20, the positive electrode plate 30, and the separator 40 including the negative electrode mixture layers 22 and the positive electrode mixture layers 32 may entirely have a constant thickness. FIG. 3 schematically illustrates the form and thickness of the negative electrode plate 20 and the positive electrode plate 30.

Each separator 40 is formed so that porosity increases in the second width direction W2. The porosity is a ratio of the volume of voids to the volume of the outer shape of the separator 40. In other words, the separator 40 is formed so that the gas permeability decreases in the second width direction W2. The gas permeability indicates the time required for the passage of a certain amount of fluid, and a greater value will mean that the passage of fluid is more restricted.

Preferably, the porosity of the separator 40 is such that the porosity at the end in the second width direction W2 is 102% or greater with respect to the porosity at the end in the first width direction W1. In the present embodiment, the porosity of the separator 40 is such that the porosity at the end in the second width direction W2 is 102% or greater with respect to the porosity at the end in the first width direction W1. In one example, the separator 40 has a first end at the side where the negative electrode connection portion 23 of the negative electrode plate 20 is located and a second end opposite to the first end in the rolling axis direction. The porosity of the separator 40 is such that the porosity at the second end may be 102% or greater with respect to the porosity at the first end. Further, the porosity of the separator 40 is such that the porosity at the end in the second width direction W2 may be 103% or greater or be 105% or greater with respect to the porosity at the end in the first width direction W1. FIG. 3 schematically illustrates the varying porosity in a gradated manner.

The porosity of the separator 40 can be varied in the width direction W by, for example, applying a different tension force to the separator 40 during manufacturing. Further, the porosity of the separator 40 can be varied in the width direction W through, for example, differences in heating temperature, time, or the like during manufacturing.

The operation and advantages of the above embodiment will now be described.

(1) The thickness of the negative electrode plate 20 increases in the first width direction W1 toward the negative electrode connection portion 23. The thickness of the positive electrode plate 30 increases in the second width direction W2 toward the positive electrode connection portion 33. Thus, the resistance is reduced near the negative electrode connection portion 23 and the positive electrode connection portion 33 where current concentrates. This improves the input/output properties of the lithium-ion rechargeable battery 10. Further, the thickness of the negative electrode plate 20 decreases in the second width direction W2, and the resistance of the negative electrode plate 20 increases in the second width direction W2. However, the increased porosity of the separator 40 in the second width direction W2 increases the replenished amount of the non-aqueous electrolyte 18 in the second width direction W2. Thus, a combined resistance of the separator 40 and the negative electrode plate 20 will be substantially constant in the width direction W. Thus, the current flowing from the positive electrode plate 30 to the negative electrode plate 20 will not concentrate at a certain portion in the width direction W during, for example, charging. Thus, the amount of deposited lithium metal will be limited since the concentration of current can be avoided. This maintains, for example, the input/output properties of the lithium-ion rechargeable battery 10 in a preferred manner. An experiment was conducted to compare the lithium-ion rechargeable battery 10 of the present embodiment with a lithium-ion rechargeable battery in which the separator 40 had a constant porosity in the width direction W. In the experiment, the current limit for avoiding deposition in the lithium-ion rechargeable battery 10 of the present embodiment was increased by 10%

(2) In the present embodiment, the thickness of the negative electrode mixture layers 22, decreased in the second width direction W2, decreases the replenished amount of the non-aqueous electrolyte 18 in the second width direction W2. Thus, the resistance of the negative electrode plate 20 increases in the second width direction W2. However, the porosity of the separator 40, increased in the second width direction W2, increases the replenished amount of the non-aqueous electrolyte 18 in the second width direction W2. Thus, the combined resistance of the separator 40 and the negative electrode plate 20 is substantially constant in the width direction W. The current flowing from the positive electrode plate 30 to the negative electrode plate 20 will not concentrate at a certain portion in the width direction W during, for example, charging. Further, the deposited amount of lithium metal will be limited since the concentration of current will be avoided. This maintains, for example, the input/output properties of the lithium-ion rechargeable battery 10 in a preferred manner.

(3) The porosity of the separator 40 at the end in the second width direction W2 is 102% or greater with respect to the porosity at the end in the first width direction W1. This maintains, for example, the input/output properties of the lithium-ion rechargeable battery 10 in a preferred manner.

(4) The negative electrode plate 20 and the positive electrode plate 30 are formed so that the total thickness when stacked is constant in the width direction W. This avoids, for example, an increased thickness and distortion in either side of the width direction W.

The present embodiment may be modified as described below. The present embodiment and the following modifications can be combined if the combined modifications remain technically consistent with each other.

In the above embodiment, in the negative electrode plate 20, the negative electrode mixture layers 22 are increased in thickness in the first width direction W1. Instead, in the negative electrode plate 20, the negative electrode substrate 21 may be increased in thickness in the first width direction W1. In this case, the negative electrode mixture layers 22 may have a constant thickness in the width direction W.

Further, in the positive electrode plate 30, the positive electrode mixture layers 32 are increased in thickness in the second width direction W2. Instead, in the positive electrode plate 30, the positive electrode substrate 31 may be increased in thickness in the second width direction W2. In this case, the positive electrode mixture layers 32 may have a constant thickness in the width direction W.

In the above embodiment, the porosity of the separator 40 at the end in the second width direction W2 is 102% or greater with respect to the porosity at the end in the first width direction W1. Instead, the porosity of the separator 40 at the end in the second width direction W2 may be 102% or less with respect to the porosity at the end in the first width direction W1.

In the above embodiment, the negative electrode plate 20 and the positive electrode plate 30 are formed so that the thickness of the entire stack is constant in the width direction W. Instead, thickness of the entire stack may vary in the width direction W in accordance with application or the like.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A lithium-ion rechargeable battery, comprising:
a negative electrode plate including a negative electrode substrate and a negative electrode mixture layer applied to each of two surfaces of the negative electrode substrate;
a positive electrode plate including a positive electrode substrate and a positive electrode mixture layer applied to each of two surfaces of the positive electrode substrate;
a separator arranged between the negative electrode plate and the positive electrode plate; and
a non-aqueous electrolyte, wherein
the negative electrode substrate includes a negative electrode connection portion that projects from the negative electrode mixture layer in a first width direction and is electrically connected to a negative electrode external terminal,
the positive electrode substrate includes a positive electrode connection portion that projects from the positive electrode mixture layer in a second width direction opposite to the first width direction and is electrically connected to a positive electrode external terminal,
the negative electrode plate has a thickness that increases in the first width direction,
the positive electrode plate has a thickness that increases in the second width direction, and
the separator has a porosity that increases in the second width direction.

2. The lithium-ion rechargeable battery according to claim 1, wherein
in the negative electrode plate, the negative electrode mixture layer has a thickness that increases in the first width direction, and
in the positive electrode plate, the positive electrode mixture layer has a thickness that increases in the second width direction.

3. The lithium-ion rechargeable battery according to claim 1, wherein the porosity of the separator is such that the porosity at an end in the second width direction is 102% or greater with respect to the porosity at an end in the first width direction.

4. The lithium-ion rechargeable battery according to claim 1, wherein the negative electrode plate and the positive electrode plate, when stacked, entirely has a thickness that is constant in a width direction.
